(19) United States
(12) Patent Application Publication
(10) Pub. No.: US 2015/0328571 A1
(43) Pub. Date: Nov. 19, 2015

(54) AXIAL FLOW TYPE DUST COLLECTOR AND PRE-COLLECTING DEVICE THEREFOR

(71) Applicants: Dong-won Son, Busan (KR); Xu Bai, ShangHai (CN); Jeong-hwa Son, Busan (KR)

(72) Inventor: Dong-won Son, Busan (KR)

(21) Appl. No.: 14/490,765

(22) Filed: Sep. 19, 2014

(30) Foreign Application Priority Data
May 16, 2014 (KR) 10-2014-0058791

(51) Int. Cl. B01D 45/16

(52) U.S. Cl. CPC B01D 45/16

(57) ABSTRACT

Disclosed are an axial flow type dust collector and a pre-collecting device for the same. The axial flow type dust collector includes: a front pre-processing section and a back post-processing section and a gas flow unit configured to include a cone-shaped diverging section for diverging flow of dirty gas introduced through an inlet and a cone-shaped converging section installed in a down stream of the cone-shaped diverging section and converging the flow of the dirty gas on a transfer tube. With these configurations, the axial flow type dust collector can be used only by pre-processing section removable, can be used as a one-piece together with it, and the loss of static pressure is small and it is easy to manage, and high collection efficiency is provided by the dust collector.

### CROSS-REFERENCE TO RELATED APPLICATION

This application claims priority from Korean Patent Application No. 10-2014-0058791, filed on May 16, 2014 in the Korean Intellectual Property Office, the disclosure of which is incorporated herein by reference.

### BACKGROUND

1. Field

Apparatuses and methods consistent with the exemplary embodiments relate to an axial flow type dust collector and a pre-collecting device for the same.

2. Description of the Related Art

An axial flow type dust collector has a cylindrical main body, both ends of which are connected to a gas inlet and a gas outlet. Dirty gas is introduced into the gas inlet and flows toward the gas outlet. The dirty gas passes through guide vanes inside the main body and forms spiral flow. While the spiral flow moves toward the gas outlet along a cylindrical inner wall, dust falls down by its own weight and is discharged through an exhaust formed at a lower side and processed air is discharged through the gas outlet provided in an axial direction.

However, such a conventional dust collector has a problem that dust containing large particles or having high viscosity is collected in a plurality of guide vanes and clogs a space between the guide vanes to thereby increase loss of static pressure and lower a dust collecting performance since the space between the guide vanes installed therein is substantially smaller than a diameter of the inlet.

### SUMMARY

An aspect of an exemplary embodiment is to provide an axial flow type dust collector and a pre-collecting device for the same, in which clogginess is prevented and thus a dust collecting performance and reliability are durably maintained.

In accordance with an exemplary embodiment, there is provided an axial flow type dust collector including: a housing configured to include an inlet at one end, an outlet at the other end, an internal collected-dust processing space, and first and second exhausts opened downward and formed in sequence along a flowing direction to be spaced apart from each other; a partition configured to be placed in between the first exhaust and the second exhaust, and partition the collected-dust processing space into a front pre-processing section and a back post-processing section; a transfer tube configured to be arranged on the same axial line as the inlet within the collected-dust processing space, and connect the pre-processing section and the post-processing section; and a gas flow unit configured to be placed in the pre-processing section, and include a cone-shaped diverging section for diverging flow of dirty gas introduced through the inlet and a cone-shaped converging section installed in a down stream of the cone-shaped diverging section and converging the flow of the dirty gas on the transfer tube.

The partition may be shaped like a disc or a funnel extended backward.

The axial flow type dust collector may further include a gas flow unit supporter fitted to the transfer tube and including a plurality of connection bars supporting for supporting the gas flow unit

The pre-processing section may include a guide section for guiding dust separated from dirty gas introduced through the inlet toward the first exhaust.

The guide section may include: a guide section front plate inclined from an end of the inlet downward at an angle of 45 to 60 degrees to guide dust; a guide section back plate vertically installed from a down stream of the pre-processing section downward; and guide section lateral plates installed between the front plate and the back plate and corresponding to each other as being converged toward a lower side in a vertical direction.

The axial flow type dust collector may further include a first dust collector and a second dust collector for respectively receiving dust discharged through the first exhaust and the second exhaust and detachably coupled to the first exhaust and the second exhaust.

In accordance with another exemplary embodiment, there is provided a pre-collecting device for an axial flow type dust collector with a post-processing section, the pre-collecting device including: a housing configured to include a pre-processing inlet at one end, a post-processing coupling mouth at the other end, and a dust exhaust opened downward; and a gas flow unit configured to be placed in the housing, and include a cone-shaped diverging section for diverging flow of dirty gas introduced through the pre-processing inlet and a cone-shaped converging section installed in a down stream of the cone-shaped diverging section and converging the flow of the dirty gas on a transfer tube.

The pre-collecting device may further include a gas flow unit supporter including a plurality of support wings for supporting the gas flow unit.

The housing may include a guide section for guiding dust separated from dirty gas introduced through the pre-processing inlet toward the dust exhaust.

The guide section may include: a guide section front plate inclined from an end of the pre-processing inlet downward at an angle of 45 to 60 degrees to guide dust; a guide section back plate vertically installed from a down stream of the pre-processing section downward; and guide section lateral plates installed between the front plate and the back plate and corresponding to each other as being converged toward a lower side in a vertical direction.

The post-processing coupling mount may be directly connected to the transfer tube, internally forms a collected-dust processing space, and include a partition extended from the transfer tube, provided as one selected among a disc shape, a funnel shape, a bellows-type tubular shape, a stepped shape and a concave-convex shape for partitioning the collected-dust processing space.

### BRIEF DESCRIPTION OF THE DRAWINGS

The above and/or other aspects will become apparent and more readily appreciated from the following description of exemplary embodiments, taken in conjunction with the accompanying drawings, in which:

FIG. 1 is an exploded perspective view of an axial flow type dust collector according to an exemplary embodiment;

FIG. 2 is a cross-section view of an axial flow type dust collector according to an exemplary embodiment; and

FIG. 3 is a sectional view of a pre-collecting device for the axial flow type dust collector.

### DETAILED DESCRIPTION OF EXEMPLARY EMBODIMENTS

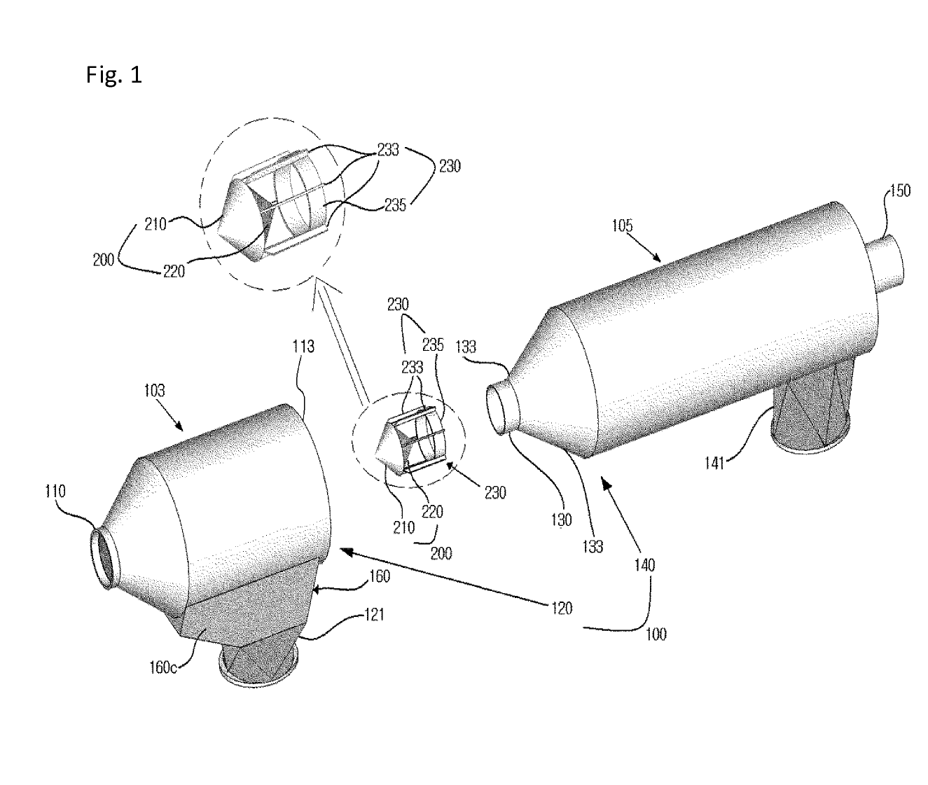

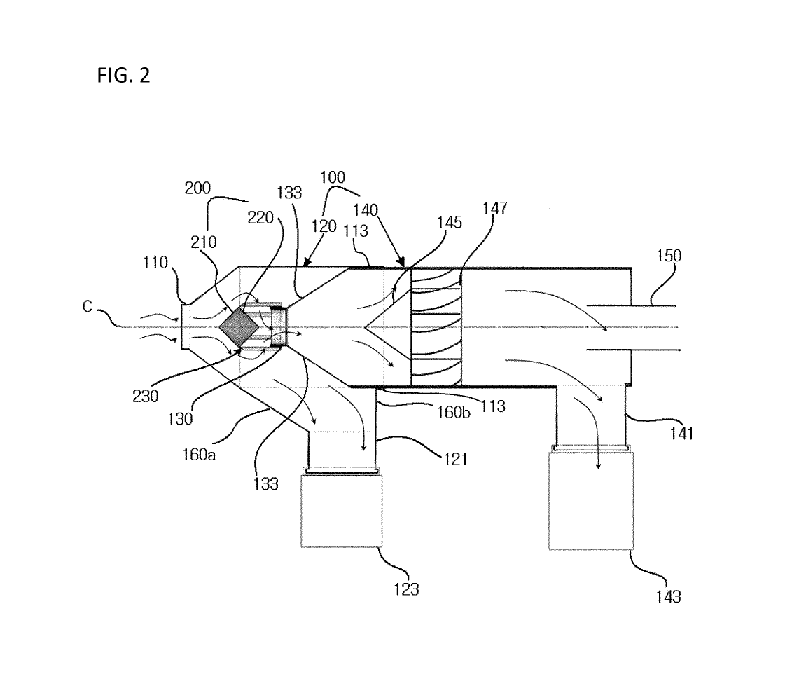

FIG. 1 is an exploded perspective view of an axial flow type dust collector according to an exemplary embodiment, and FIG. 2 is a cross-section view of the axial flow type dust collector. As shown therein, the axial flow type dust collector according to an exemplary embodiment includes a housing 100 formed with an inlet 110 at one end, an outlet 150 at the other end, and a dust processing space therein. The housing 100 includes a first exhaust 121 and a second exhaust 141 spaced part from each other along a flowing direction and opened downward in sequence. The first exhaust 121 and the second exhaust 141 are respectively fitted and coupled to a first dust collector 123 and a second dust collector 143 for keeping and removing collected dust.

Between the first exhaust 121 and the second exhaust 141 is arranged a partition 133 for partitioning a collected-dust processing space inside the housing 100 into a pre-processing section 120 and a post-processing section 140 along a flowing direction. The housing 100 is partitioned into a pre-processing housing 103 and a post-processing housing 105 with the partition 133 therebetween, in which the post-processing housing 105 is fitted to a post-processing coupling mouth 113 formed along an circumferential end of the pre-processing housing 103 in an axial direction.

At a center region in an axial direction of the partition 133, a transfer tube 130 is provided to communicate the pre-processing section 120 and the post-processing section 140 with each other, in which the partition 133 is shaped like a funnel that becomes wider backward from the transfer tube 130. Such a funnel shape of the partition 133 can efficiently remove dust containing large particles or having high viscosity without interfering with a channel for air. In this embodiment shown in the drawings, the partition 133 is shaped like a funnel, but not limited thereto. Alternatively, the partition 133 may have a bellows-type tubular shape based on a surface process, a stepped shape, a concave-convex shape, a spiral shape, etc. Likewise, the transfer tube 130 may be shaped like a funnel different in inclination from the partition 133.

At a center region inside the pre-processing section 120, a gas flow unit 200 is provided. The gas flow unit 200 includes a pre-processing diffuser having a cross-section area that becomes larger backward in a flowing direction of gas, and a pre-processing converger placed in back of the pre-processing diffuser and having a cross-section area that becomes smaller backward. The pre-processing diffuser and the pre-processing converger may be respectively achieved by a cone-shaped diverging section 210 arranged to have a cone shape and a cone-shaped converging section 220 arranged to have a reversed cone shape. Such a con shape efficiently controls flow of introduced dirty gas to be diverged and converged.

As solid shapes for forming the pre-processing diffuser and the pre-processing converger, a cone shape is preferable, but not limited thereto. Besides, a truncated cone, a polypyramid or the like solid shape having a narrow upper portion and a wide lower portion may also be preferable.

In order to efficiently control the flow of the dirty gas and improve the whole efficiency of the dust collector, the pre-processing diffuser and the pre-processing converger of the gas flow unit 200 are achieved in such a manner that the cone-shaped diverging section 210 and the cone-shaped converging section 220 are coupled having the same shape. The pre-processing diffuser and converger may have sold shapes asymmetrical to each other as well as solid shapes symmetrical to each other with respect to a coupling point.

In this embodiment, the cone-shaped diverging section 210 and the cone-shaped converging section 220 are coupled as a single body, but not limited thereto. Alternatively, the cone-shaped diverging section 210 and the cone-shaped converging section 220 may be spaced apart from each other along the axial direction. In the case where the cone-shaped diverging section 210 and the cone-shaped converging section 220 may be spaced apart from each other along the axial direction, extended portions (not shown) are connected in parallel from a back end of the cone-shaped diverging section to a front end of the cone-shaped converging section. Alternatively, the extended portions (not shown) may be formed to have a curvature or slope. The extended portion (not shown) may have a cylindrical shape to connect both cone-shaped sections 210 and 220. The extended portion may have various shapes depending on the ends of both cone-shaped sections 210 and 220. Also, the surface of the extended portion may undergo tapping to facilitate the diffusion of the dirty gas, thereby efficiently controlling the flow of gas.

The gas flow unit 200 includes a fastening ring 236 fitted and fastened to the transfer tube 130, and connection bars 233 connecting the fastening ring 236 with the cone-shaped sections 210 and 220 or the extended portion (not shown). Thus, the cone-shaped sections 210 and 220 are stably positioned and settled along an axial line of the pre-processing section 120. Dirty gas introduced by the cone-shaped sections 210 and 220 is diverged and converged and flows toward the post-processing section 140 through the transfer tube 130, thereby separating dust having large particles and high viscosity. To easily converge the transferred flow, the cone-shaped converging section 220 is properly spaced apart from the transfer tube 130, thereby preventing the cross-section of the channel from being narrowed and minimizing loss of static pressure.

The pre-processing section 120 includes a guide section 160 at a lower side so as to discharge fallen dust to the first exhaust 121. The guide section 160 is inclined from the end of the inlet 110 downward at an angle of 45 to 60 degrees so as to prevent deposition of dust separated while the dirty gas is diverged and converged. The guide section 160 includes a guide section front plate 160a for guiding movement of dust. If the angle is smaller than 45 degree, it is not easy to guide the movement of dust. On the other hand, if the angle is greater than 60 degrees, the size of dust collector is unnecessarily increased, and an efficiency of collecting dust is lowered. Further, the guide section 160 includes a guide section back plate 160b vertically installed from a downstream of the pre-processing section 120 downward, and guide section lateral plates 160c installed between the front plate 160a and the back plate 160b and corresponding to each other as being converged toward a lower side in a vertical direction.

The dirty gas introduced through the inlet and diffused and converged within the pre-processing section 120 is diffused in a radial direction along the surface of the cone-shaped diverging section 210 while contacting the cone-shaped diverging section 210, so that dust containing large particles and having high viscosity can fall and be discharged. After removing the dust containing large particles or high viscosity, dry dirty gas containing small dust is converged into the transfer tube 130 along the surface of the cone-shaped converging section 220 and guided to the post-processing section 140.

The post-processing section 140 includes a plurality of guide vanes 147 radially arranged between the transfer tube 130 and the outlet 150, and a post-processing diffuser 145 coupled to a front end portion of the guide vane 147. The dirty gas introduced into the post-processing section through the transfer tube 130 is diffused along the post-processing diffuser 145 while contacts the post-processing diffuser 145, and flows into the guide vanes 147. The plurality of guide vanes 147 are radially diverged from an apex of the post-processing diffuser 145 toward an outer wall along an inclined surface. The diverged guide vanes 147 has a gentle inlet angle of 0 to 5 degrees at a front end portion and has a steep outlet angle of 75 to 80 degrees at a back end portion with regard to the axial line. Such an outlet angle minimizes loss of static pressure and enhances an efficiency of collecting dust.

While the diffused dirty gas flows toward the outlet 150, dust is separated by the centrifugal force of the guide vanes 147 and its own weight and discharged through the second exhaust 141, and then collected and processed in the second dust collector 143 like that in the first dust collector 123.

In the embodiment shown in FIGS. 1 and 2, the pre-processing section 120 and the post-processing section 140 are separated from and coupled to each other in the axial direction. Also, the gas flow unit 230 and the partition 133 are provided in the pre-processing section, and the post-processing diffuser 145 and the guide vanes 147 are provided in the post-processing section 140, so that they can be respectively included in the dust collector as individual elements and the elements can be selectively divided. Thus, the pre-processing section 120 and the elements may constitute a pre-collecting device for the axial flow type dust collector, and the post-processing section 140 and the elements may constitute a post-collecting device for the axial flow type dust collector.

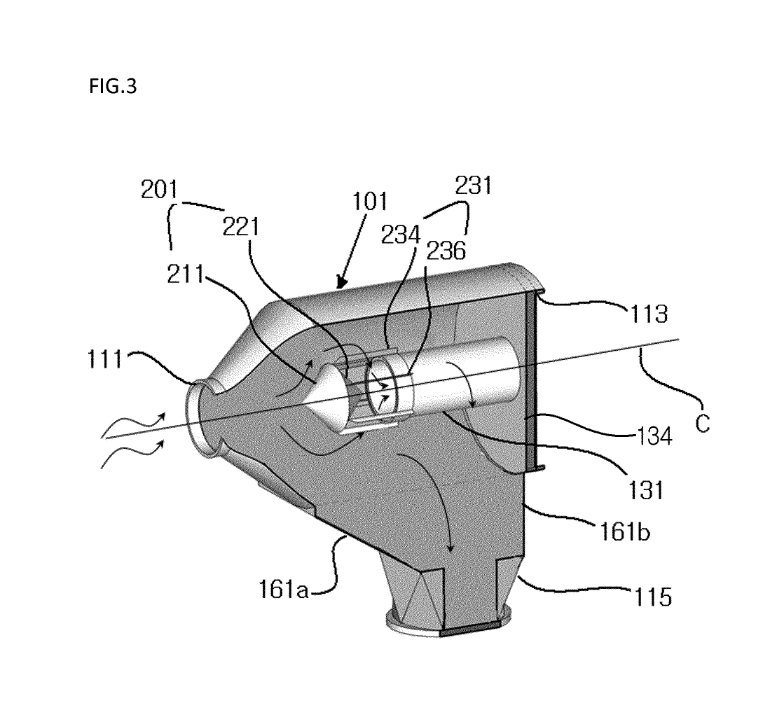

FIG. 3 is a sectional view of a pre-collecting device for the axial flow type dust collector according to another exemplary embodiment. As compared with to those of FIGS. 1 and 2, repetitive descriptions will be avoided. Referring to FIG. 3, the pre-processing section 120 includes a pre-processing inlet 111 at one end, a post-processing coupling mouth 113 at the other end, an internally formed collected-dust processing space, and a dust exhaust 115 opened downward. The transfer tube 131 and the partition 134 are directly coupled to the post-processing coupling mouth 113.

In this embodiment, the partition 134 is shaped like a disc and arranged transversely to the axial direction of the pre-processing inlet 111. The partition 134 shaped like a disc forms the collected-dust processing space so that dirty gas introduced from the pre-processing inlet 111 can be diffused and collected along the surface of the gas flow unit 201, thereby having an effect on collecting the dust.

The cone-shaped diverging section 211 and the cone-shaped converging section 221 of the gas flow unit 201 in this embodiment may be achieved by the same pre-processing diffuser/converger as shown in FIGS. 1 and 2.

In this embodiment, the transfer tube 131 is connected to the partition 134 shaped like a disc, and more extended in the axial direction than the transfer tube 130 of FIGS. 1 and 2. The transfer tube 131 has a cylindrical shape. Alternatively, the transfer tube may be shaped like a funnel having a cross section increased backward. Besides, the transfer tube 131 and the partition 134 may be respectively shaped like funnels different in slope from each other and having the cross-sections increased backward.

To couple the gas flow unit 201 with the transfer tube 131, support wings 234 for connection between the fastening ring 236 and the cone-shaped sections 211 and 221 may be provided as a thin plate on the contrary to the connection bar 233 of FIGS. 1 and 2.

Therefore, there is provided the axial flow type dust collector, in which the gas flow units 200 and 201 provided in the pre-processing section 120 can efficiently collect dust containing large particles and having high viscosity, and the dust can be additionally collected through the post-processing diffuser 145 and the guide vanes 147 of the post-processing section 140, thereby decreasing loss of the static pressure. Accordingly, the axial flow type dust collector can be used only by pre-processing section removable, and can be used as a one-piece by connecting post-processing section and pre-processing section with each other.

As described above, it is possible to maintain dust collecting performance, reliability and durability as clogginess is prevented.

Although a few exemplary embodiments have been shown and described, it will be appreciated by those skilled in the art that changes may be made in these exemplary embodiments without departing from the principles and spirit of the invention, the scope of which is defined in the appended claims and their equivalents.

What is claimed is:

1. An axial flow type dust collector comprising:
a housing configured to comprise an inlet at one end, an outlet at the other end, an internal collected-dust processing space, and first and second exhausts opened downward and formed in sequence along a flowing direction to be spaced apart from each other;
a partition configured to be placed in between the first exhaust and the second exhaust, and partition the collected-dust processing space into a front pre-processing section and a back post-processing section;
a transfer tube configured to be arranged on the same axial line as the inlet within the collected-dust processing space, and connect the pre-processing section and the post-processing section; and
a gas flow unit configured to be placed in the pre-processing section, and comprise a cone-shaped diverging section for diverging flow of dirty gas introduced through the inlet and a cone-shaped converging section installed in a down stream of the cone-shaped diverging section and converging the flow of the dirty gas on the transfer tube.

2. The axial flow type dust collector according to claim 1, wherein the partition is shaped like a disc or a funnel extended backward.

3. The axial flow type dust collector according to claim 1, further comprising a gas flow unit supporter fitted to the transfer tube and comprising a plurality of connection bars supporting for supporting the gas flow unit.

4. The axial flow type dust collector according to claim 1, the pre-processing section comprises a guide section for guiding dust separated from dirty gas introduced through the inlet toward the first exhaust.

5. The axial flow type dust collector according to claim 4, wherein the guide section comprises:
a guide section front plate inclined from an end of the inlet downward at an angle of 45 to 60 degrees to guide dust;
a guide section back plate vertically installed from a down stream of the pre-processing section downward; and
guide section lateral plates installed between the front plate and the back plate and corresponding to each other as being converged toward a lower side in a vertical direction.

6. The axial flow type dust collector according to claim 1, further comprising a first dust collector and a second dust collector for respectively receiving dust discharged through the first exhaust and the second exhaust and detachably coupled to the first exhaust and the second exhaust.

7. A pre-collecting device for an axial flow type dust collector with a post-processing section, the pre-collecting device comprising:
a housing configured to comprise a pre-processing inlet at one end, a post-processing coupling mouth at the other end, and a dust exhaust opened downward; and
a gas flow unit configured to be placed in the housing, and comprise a cone-shaped diverging section for diverging flow of dirty gas introduced through the pre-processing inlet and a cone-shaped converging section installed in a down stream of the cone-shaped diverging section and converging the flow of the dirty gas on a transfer tube.

8. The pre-collecting device according to claim 7, further comprising a gas flow unit supporter comprising a plurality of support wings for supporting the gas flow unit.

9. The pre-collecting device according to claim 7, wherein the housing comprises a guide section for guiding dust separated from dirty gas introduced through the pre-processing inlet toward the dust exhaust.

10. The pre-collecting device according to claim 9, wherein the guide section comprises:
a guide section front plate inclined from an end of the pre-processing inlet downward at an angle of 45 to 60 degrees to guide dust;
a guide section back plate vertically installed from a down stream of the pre-processing section downward; and
guide section lateral plates installed between the front plate and the back plate and corresponding to each other as being converged toward a lower side in a vertical direction.

11. The pre-collecting device according to claim 7, wherein the post-processing coupling mount is directly connected to the transfer tube, internally forms a collected-dust processing space, and comprises a partition extended from the transfer tube, provided as one selected among a disc shape, a funnel shape, a bellows-type tubular shape, a stepped shape and a concave-convex shape for partitioning the collected-dust processing space.
